(19) United States
(12) Patent Application Publication
(10) Pub. No.: US 2024/0202854 A1
(43) Pub. Date: Jun. 20, 2024

(54) METHOD TO COMPUTE PEDESTRIAN REAL-TIME VULNERABILITY INDEX

(71) Applicant: HERE GLOBAL B.V., Eindhoven (NL)

(72) Inventor: Jerome BEAUREPAIRE, COURBEVOIE (FR)

(73) Assignee: HERE GLOBAL B.V., EINDHOVEN (NL)

(21) Appl. No.: 18/083,317

(22) Filed: Dec. 16, 2022

(51) Int. Cl. G06Q 50/26

(52) U.S. Cl. CPC G06Q 50/265

(57) ABSTRACT

A system, a method and a computer program product to compute a pedestrian real-time vulnerability index are disclosed. For example, the system is configured to obtain static information related to the geographic region near the pedestrian and/or dynamic information related to the geographic region near the pedestrian. The system is configured to compute the real-time vulnerability index for the pedestrian based on the static information related to the geographic region near the pedestrian and/or the dynamic information related to the geographic region near the pedestrian. The system may alert the pedestrian to the real-time vulnerability index with a pedestrian advisory indication.

### TECHNOLOGICAL FIELD

An example aspect of the present disclosure generally relates to determining a pedestrian risk index, and more particularly, but without limitation relates to a system, a method, and a computer program product for computing a pedestrian real-time vulnerability index.

### BACKGROUND

Pedestrians walking in urban street may not always realize their vulnerability in relation to their immediate surroundings, especially how well they are seen by vehicles. In addition, more and more users get distracted by mobile phones when crossing streets, thus it is expected that pedestrians may not always pay attention to their surroundings.

In cities, many street features are reducing drivers' and pedestrians' visibility, such as parked vehicles, advertisements, other people, walls, signs, street lights, trees, bridges, etc.

### BRIEF SUMMARY

In an aspect of the disclosure, a system to compute a pedestrian real-time vulnerability index is disclosed. The system is configured to obtain static information related to the geographic region near the pedestrian and/or dynamic information related to the geographic region near the pedestrian. The system is configured to compute the real-time vulnerability index for the pedestrian based on the static information related to the geographic region near the pedestrian and/or the dynamic information related to the geographic region near the pedestrian. The system may alert the pedestrian to the real-time vulnerability index with a pedestrian advisory indication.

In an aspect of the disclosure, method to compute a pedestrian real-time vulnerability index is disclosed. The method obtains static information related to the geographic region near the pedestrian and/or dynamic information related to the geographic region near the pedestrian. The method computes the real-time vulnerability index for the pedestrian based on the static information related to the geographic region near the pedestrian and/or the dynamic information related to the geographic region near the pedestrian. The method may alert the pedestrian to the real-time vulnerability index with a pedestrian advisory indication.

In an aspect of the disclosure, a computer program product comprising a non-transitory computer readable medium having stored thereon computer executable instructions, which when executed by one or more processors, cause the one or more processors to carry out operations to compute a pedestrian real-time vulnerability index is disclosed. The computer program product includes operations for obtaining static information related to the geographic region near the pedestrian and/or dynamic information related to the geographic region near the pedestrian. The computer program product includes operations for computing the real-time vulnerability index for the pedestrian based on the static information related to the geographic region near the pedestrian and/or the dynamic information related to the geographic region near the pedestrian. The computer program product includes operations for alerting the pedestrian to the real-time vulnerability index with a pedestrian advisory indication.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF THE DRAWINGS

Having thus described certain aspects of the disclosure in general terms, reference will now be made to the accompanying drawings, which are not necessarily drawn to scale, and wherein:

FIG. 1 illustrates a schematic diagram of a network environment 100 of a system 102 for computing a pedestrian real-time vulnerability index, according to an aspect of the disclosure;

FIG. 2 illustrates a block diagram of the system for computing a pedestrian real-time vulnerability index, according to an aspect of the disclosure;

FIG. 3 illustrates an example the map or geographic database for use by the system for computing a pedestrian real-time vulnerability index, according to an aspect of the disclosure; and

FIG. 4 illustrates a flowchart for acts taken in an exemplary method for computing a pedestrian real-time vulnerability index, according to an aspect of the disclosure.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

For purposes of this disclosure, though not limiting or exhaustive, “vehicle” refers to standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle (“AV”) may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one aspect, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

For purposes of this disclosure, though not limiting or exhaustive, “transfer learning” refers to a technique in in machine learning (ML) that focuses on storing knowledge gained while solving one problem and applying it to a different but related problem, where transfer learning attempts to use a source domain of prior data from a different but related context and a prior target domain to generate a new target predictive function for the new data set being evaluated for the first time.

Pedestrians walking in urban street may not always realize their vulnerability in relation to their immediate surroundings, especially how well they are seen by vehicles. This disclosure is about helping them better evaluate such risk based on all the available data related to the environment as well as historical data.

In cities, many street features are reducing drivers and pedestrians' visibility: parked vehicles, advertisements, other people, walls, signs, street lights, trees, bridges, etc.

However, it is not always clear for a pedestrian to understand or realize how well (or not) s/he can be seen by the car/truck drivers. Therefore, a need exists for knowledge or indication of what is a pedestrian's visibility to upcoming drivers, ideally in real time or ahead of time for a path we are about to take.

Accordingly, there is a need for alerting a pedestrian, preferably in real-time, to his/her vulnerability in a street environment where vehicle operators (which can be human-driven, AV or a hybrid of both) may not see the pedestrian, and to send an alert to the pedestrian based on the pedestrian vulnerability index.

How can such a vulnerability index be computed? First of all, the pedestrian real-time vulnerability index depends a lot on the line of sight (LoS) between a vehicle and the pedestrian and the ability to be able to clearly see the movements of pedestrians. Therefore the system may consider static information such as map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof. The system may also consider dynamic information such a detected presence and/or a reported presence of vehicles in parking lanes, dimensions of vehicles in parking lanes, vehicle speeds in the geographic region, real-time weather conditions, traffic conditions, presence of street lighting and shadows or a combination thereof.

The present disclosure addresses pedestrian vulnerability due to their visibility in the current environment. In an aspect, the present disclosure computes a pedestrian real-time vulnerability index to warn the pedestrian of hazardous road crossings where vehicles may not see the pedestrian in time to avoid an accident with the pedestrian. The present disclosure may compute the pedestrian real-time vulnerability index based on static features and dynamic features of the area in which the pedestrian is walking. The present disclosure may allow for an alert or a guidance to the pedestrian as he/she is walking towards a hazardous intersection. The present disclosure may also provide an alert to AVs in the area to be more alert to unseen pedestrians based on the pedestrian real-time vulnerability index.

In an aspect of the disclosure, user interfaces (“UI”) may present/display/alert a pedestrian of an upcoming hazardous road crossing condition, where LOS visibility for a pedestrian is low or other static features and dynamic features may reduce visibility of pedestrians in the area. A UI interfaced with an AV or non-AV may also receive alerts regarding a pedestrian real-time vulnerability index and notification through the UI that there may be areas of low LoS or low pedestrian visibility to be aware of and to exercise more caution or take different routes, for example. Examples of UI alerts may include an audible alert, a visual alert, a vehicle console display alert, an in-vehicle infotainment (“IVI”) alert, an augmented reality-based alert, a heads-up display alert, a haptic alert, etc. for either the pedestrian or vehicle.

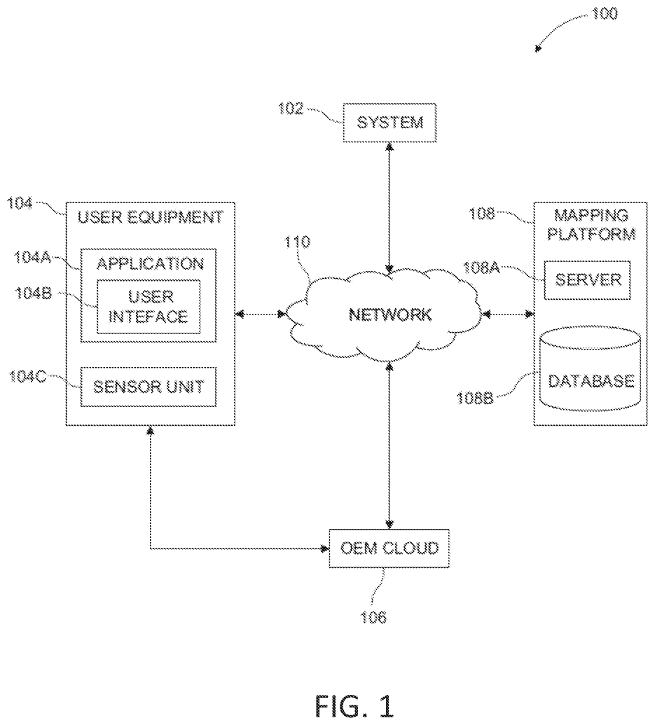

FIG. 1 illustrates a schematic diagram of a network environment 100 of a system 102 for computing a pedestrian real-time vulnerability index in accordance with an example aspect. The system 102 may be communicatively coupled with, a user equipment (UE) 104, an OEM cloud 106, a mapping platform 108, via a network 110. The UE 104 may be a vehicle electronics system, onboard automotive electronics/computers, a mobile device such as a smartphone, tablet, smart watch, smart glasses, laptop, wearable device or other UE platforms known to one of skill in the art. The mapping platform 108 may further include a server 108A and a database 108B. The user equipment includes an application 104A, a user interface 104B, and a sensor unit 104C. Further, the server 108A and the database 108B may be communicatively coupled to each other.

The system 102 may comprise suitable logic, circuitry, interfaces and code that may be configured to process the sensor data obtained from the UE 104 for historical, static information and real-time, dynamic information related to the geographic region where the pedestrian is walking, that may be used to compute a pedestrian real-time vulnerability index based in part on sensor data. The system 102 may be communicatively coupled to the UE 104, the OEM cloud 106, and the mapping platform 108 directly via the network 110. Additionally, or alternately, in some example aspects, the system 102 may be communicatively coupled to the UE 104 via the OEM cloud 106 which in turn may be accessible to the system 102 via the network 110.

All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed. Furthermore, fewer or additional components may be in communication with the system 102, within the scope of this disclosure.

The system 102 may be embodied in one or more of several ways as per the required implementation. For example, the system 102 may be embodied as a cloud-based service or a cloud-based platform. As such, the system 102 may be configured to operate outside the UE 104. However, in some example aspects, the system 102 may be embodied within the UE 104. In each of such aspects, the system 102 may be communicatively coupled to the components shown in FIG. 1 to carry out the desired operations and wherever required modifications may be possible within the scope of the present disclosure.

The UE 104 may be a vehicle electronics system, in-vehicle infotainment (“IVI”) system, onboard automotive electronics/computers, a mobile device such as a smartphone, tablet, smart watch, smart glasses, laptop, wearable device and the like that is portable in itself or as a part of another portable/mobile object, such as, a vehicle known to one of skill in the art. In an aspect of the disclosure, the UE 104 may be embodied with in a drone or other unmanned autonomous vehicle in communication with the system 102. The UE 104 may comprise a processor, a memory and a network interface. The processor, the memory and the network interface may be communicatively coupled to each other. In some example aspects, the UE 104 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example aspects, the UE 104 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the UE 104. Additional, different, or fewer components may be provided. For example, the UE 104 may be configured to execute and run mobile applications such as a messaging application, a browser application, a navigation application, and the like. In accordance with an aspect, the UE 104 may be directly coupled to the system 102 via the network 110. For example, the UE 104 may be a dedicated vehicle (or a part thereof) for gathering data for development of the map data in the database 108B. In some example aspects, the UE 104 may be coupled to the system 102 via the OEM cloud 106 and the network 110. For example, the UE 104 may be a consumer mobile phone (or a part thereof) and may be a beneficiary of the services provided by the system 102. In some example aspects, the UE 104 may serve the dual purpose of a data gatherer and a beneficiary device. The UE 104 may be configured to provide sensor data to the system 102. In accordance with an aspect, the UE 104 may process the sensor data for static information and dynamic information that may be used to compute a pedestrian real-time vulnerability index in the geographic region where the pedestrian is located. Further, in accordance with an aspect, the UE 104 may be configured to perform processing related to alerting a pedestrian or vehicle operator to the pedestrian real-time vulnerability index with a pedestrian warning indicator directed to the pedestrian and/or the vehicle operator.

The UE 104 may include the application 104A with the user interface 104B to access one or more applications. The application 104B may correspond to, but not limited to, map related service application, navigation related service application and location-based service application. In other words, the UE 104 may include the application 104A with the user interface 104B.

The sensor unit 104C may be embodied within the UE 104. The sensor unit 104C comprising one or more sensors may capture sensor data, in a certain geographic location. In accordance with an aspect, the sensor unit 104C may be built-in, or embedded into, or within interior of the UE 104. The one or more sensors (or sensors) of the sensor unit 104C may be configured to provide the sensor data comprising location data associated with a location of a user. In accordance with an aspect, the sensor unit 104C may be configured to transmit the sensor data to an Original Equipment Manufacturer (OEM) cloud. Examples of the sensors in the sensor unit 104C may include, but not limited to, a microphone, a camera, an acceleration sensor, a gyroscopic sensor, a LIDAR sensor, an ultrasonic detector, a proximity sensor, a weather sensor and a motion sensor.

The sensor data may refer to sensor data collected from a sensor unit 104C in the UE 104. In accordance with an aspect, the sensor data may be collected from a large number of mobile phones. In accordance with an aspect, the sensor data may refer to the point cloud data. The point cloud data may be a collection of data points defined by a given coordinates system. In a 3D coordinates system, for instance, the point cloud data may define the shape of some real or created physical objects. The point cloud data may be used to create 3D meshes and other models used in 3D modelling for various fields. In a 3D Cartesian coordinates system, a point is identified by three coordinates that, taken together, correlate to a precise point in space relative to a point of origin. The LIDAR point cloud data may include point measurements from real-world objects or photos for a point cloud data that may then be translated to a 3D mesh or NURBS or CAD model. In accordance with an aspect, the sensor data may be converted to units and ranges compatible with the system 102, to accurately receive the sensor data at the system 102. Additionally, or alternately, the sensor data of a UE 104 may correspond to movement data associated with a user of the user equipment. Without limitations, this may include motion data, position data, orientation data with respect to a reference and the like.

The mapping platform 108 may comprise suitable logic, circuitry, interfaces and code that may be configured to store map data associated with a geographic area around and including an intersection where a turn may take place. The map data may include static information and include historical road layouts, such as pre-existing road networks, map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof. The server 108A of the mapping platform 108 may comprise processing means and communication means. For example, the processing means may comprise one or more processors configured to process requests received from the system 102 and/or the UE 104. The processing means may fetch map data from the database 108B and transmit the same to the system 102 and/or the UE 104 in a suitable format. In one or more example aspects, the mapping platform 108 may periodically communicate with the UE 104 via the processing means to update a local cache of the map data stored on the UE 104. Accordingly, in some example aspects, map data may also be stored on the UE 104 and may be updated based on periodic communication with the mapping platform 108.

In an aspect, the map data may include, and the database 108B of the mapping platform 108 may store real-time, dynamic data about static information and/or dynamic information to assist and alert the pedestrian of vulnerability risk in a geographic region due to factors related to the static and/or dynamic information. For example, dynamic information may be collected for a detected presence and/or a reported presence of vehicles in parking lanes, dimensions of vehicles in parking lanes, vehicle speeds in the geographic region, real-time weather conditions, traffic conditions, presence of street lighting and shadows or a combination thereof. Other data records may include computer code instructions and/or algorithms for executing a trained machine learning model that is capable of computing a pedestrian real-time vulnerability index.

The database 108B of the mapping platform 108 may store map data of one or more geographic regions that may correspond to a city, a province, a country or of the entire world. The database 108B may store point cloud data collected from the UE 104. The database 108B may store data such as, but not limited to, node data, road segment data, link data, point of interest (POI) data, link identification information, and heading value records. The database 108B may also store cartographic data, routing data, and/or maneuvering data. According to some example aspects, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities for identifying location of building.

Optionally, the database 108B may contain path segment and node data records, such as shape points or other data that may represent pedestrian paths, links or areas in addition to or instead of the vehicle road record data. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The database 108B may also store data about the POIs and their respective locations in the POI records. The database 108B may additionally store data about places, such as cities, towns, or other communities, and other geographic features such as bodies of water, and mountain ranges. Such place or feature data can be part of the POI data or can be associated with POIs or POI data records (such as a data point used for displaying or representing a position of a city). In addition, the database 108B may include event data (e.g., traffic incidents, construction activities, scheduled events, unscheduled events, accidents, diversions etc.) associated with the POI data records or other records of the database 108B. Optionally or additionally, the database 108B may store 3D building maps data (3D map model of objects) of structures, topography and other visible features surrounding roads and streets.

The database 108B may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the UE 104. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the database 108B may be a master geographic database, but in alternate aspects, the database 108B may be embodied as a client-side map database and may represent a compiled navigation database that may be used in or with end user devices (such as the UE 104) to provide navigation and/or map-related functions. In such a case, the database 108B may be downloaded or stored on the end user devices (such as the UE 104).

The network 110 may comprise suitable logic, circuitry, and interfaces that may be configured to provide a plurality of network ports and a plurality of communication channels for transmission and reception of data, such as the sensor data, map data from the database 108B, etc. Each network port may correspond to a virtual address (or a physical machine address) for transmission and reception of the communication data. For example, the virtual address may be an Internet Protocol Version 4 (IPv4) (or an IPV6 address) and the physical address may be a Media Access Control (MAC) address. The network 110 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBec, EDGE, infrared (IR), IEEE 802.11, 802.16, cellular communication protocols, and/or Bluetooth (BT) communication protocols.

Examples of the network 110 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) networks (for e.g. LTE-Advanced Pro), 5G New Radio networks, ITU-IMT 2020 networks, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

The system, apparatus, method and computer program product described above may be or may be implemented on any of a wide variety of computing devices and may be embodied by either the same or different computing devices. The system, apparatus, etc. may be embodied by a server, a computer workstation, a distributed network of computing devices, a personal computer, an embedded processor, ASIC, FPGA or any other type of computing device. The system, apparatus, method and computer program product may be configured to compute a pedestrian real-time vulnerability index may similarly be embodied by the same or different server, computer workstation, distributed network of computing devices, personal computer, or other type of computing device.

Alternatively, the system, apparatus, method and computer program product may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

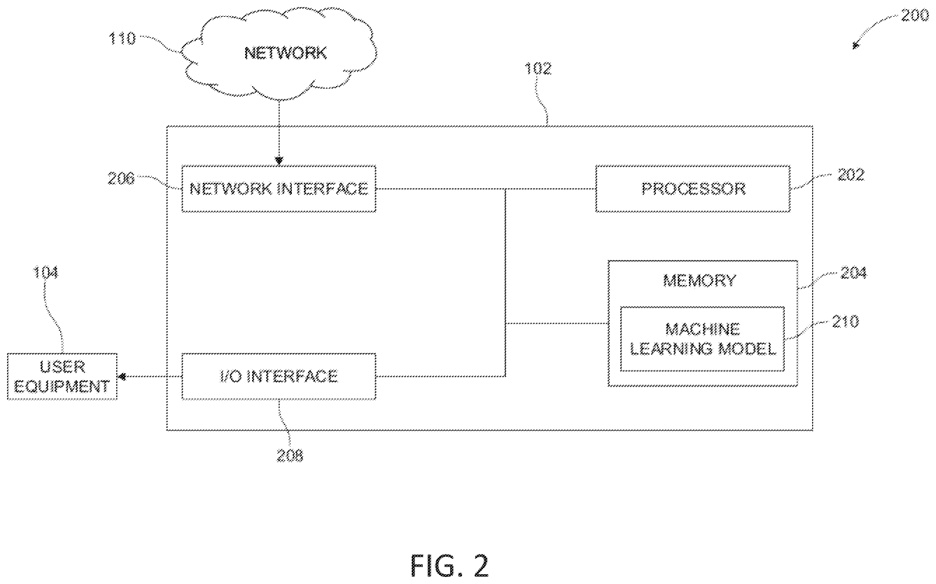

FIG. 2 illustrates a block diagram 200 of the system 102, exemplarily illustrated in FIG. 1, for computing a pedestrian real-time vulnerability index, in accordance with an example aspect. FIG. 2 is described in conjunction with elements from FIG. 1.

As shown in FIG. 2, the system 102 may comprise a processing means such as a processor 202, storage means such as a memory 204, a communication means, such as a network interface 206, an input/output (I/O) interface 208, and a machine learning model 210. The processor 202 may retrieve computer executable instructions that may be stored in the memory 204 for execution of the computer executable instructions. The system 102 may connect to the UE 104 via the I/O interface 208. The processor 202 may be communicatively coupled to the memory 204, the network interface 206, the I/O interface 208, and the machine learning model 210.

The processor 202 may comprise suitable logic, circuitry, and interfaces that may be configured to execute instructions stored in the memory 204. The processor 202 may obtain static, historical information, such as map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof. The dynamic, real-time information may be sensor data captured or otherwise obtained by one or more UE, such as the UE 104. The processor 202 may be configured to compute a pedestrian real-time vulnerability index, based on the sensor data and dynamic information such as a detected presence and/or a reported presence of vehicles in parking lanes, dimensions of vehicles in parking lanes, vehicle speeds in the geographic region, real-time weather conditions, traffic conditions, presence of street lighting and shadows or a combination thereof. The processor 202 may be further configured to compute, using a trained machine learning model, compute a pedestrian real-time vulnerability index, from static and/or dynamic information associated with the geographic area surrounding and including the intersection.

Examples of the processor 202 may be an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor, and/or other processors or circuits. The processor 202 may implement a number of processor technologies known in the art such as a machine learning model, a deep learning model, such as a recurrent neural network (RNN), a convolutional neural network (CNN), and a feed-forward neural network, or a Bayesian model. As such, in some aspects, the processor 202 may include one or more processing cores configured to perform independently. A multi-core processor may enable multiprocessing within a single physical package.

Additionally, or alternatively, the processor 202 may include one or more processors configured in tandem via the bus to enable independent execution of instructions, pipelining and/or multithreading. Additionally, or alternatively, the processor 202 may include one or processors capable of processing large volumes of workloads and operations to provide support for big data analysis. However, in some cases, the processor 202 may be a processor specific device (for example, a mobile terminal or a fixed computing device) configured to employ an aspect of the disclosure by further configuration of the processor 202 by instructions for performing the algorithms and/or operations described herein.

In some aspects, the processor 202 may be configured to provide Internet-of-Things (IoT) related capabilities to users of the UE 104 disclosed herein. The IoT related capabilities may in turn be used to provide smart city solutions by providing real time parking updates, big data analysis, and sensor-based data collection for providing navigation and parking recommendation services. The environment may be accessed using the I/O interface 208 of the system 102 disclosed herein.

The memory 204 may comprise suitable logic, circuitry, and interfaces that may be configured to store a machine code and/or instructions executable by the processor 202. The memory 204 may be configured to store information including processor instructions for training the machine learning model. The memory 204 may be used by the processor 202 to store temporary values during execution of processor instructions. The memory 204 may be configured to store different types of data, such as, but not limited to, sensor data from the UE 104. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may comprise suitable logic, circuitry, and interfaces that may be configured to communicate with the components of the system 102 and other systems and devices in the network environment 100, via the network 110. The network interface 206 may communicate with the UE 104, via the network 110 under the control of the processor 202. In one aspect, the network interface 206 may be configured to communicate with the sensor unit 104C disclosed in the detailed description of FIG. 1. In an alternative aspect, the network interface 206 may be configured to receive the sensor data from the OEM cloud 106 over the network 110 as described in FIG. 1. In some example aspects, the network interface 206 may be configured to receive location information of a user associated with a UE (such as, the UE 104), via the network 110. In accordance with an aspect, a controller of the UE 104 may receive the sensor data from a positioning system (for example, a GPS or GLNSS-based positioning system) of the UE 104. The network interface 206 may be implemented by use of known technologies to support wired or wireless communication of the system 102 with the network 110. Components of the network interface 206 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The I/O interface 208 may comprise suitable logic, circuitry, and interfaces that may be configured to operate as an I/O channel/interface between the UE 104 and different operational components of the system 102 or other devices in the network environment 100. The I/O interface 208 may facilitate an I/O device (for example, an I/O console) to receive an input (e.g., sensor data from the UE 104 for a time duration) and present an output to one or more UE (such as, the UE 104) based on the received input. In accordance with an aspect, the I/O interface 208 may obtain the sensor data from the OEM cloud 106 to store in the memory 202. The I/O interface 208 may include various input and output ports to connect various I/O devices that may communicate with different operational components of the system 102. In accordance with an aspect, the I/O interface 208 may be configured to output the pedestrian real-time vulnerability index and/or alerts or warnings related to the pedestrian real-time vulnerability index, such as, the UE 104 of FIG. 1.

In example aspects, the I/O interface 208 may be configured to provide the data associated with pedestrian real-time vulnerability indices to the database 108A to update the map of a certain geographic region. In accordance with an aspect, a user requesting information in a geographic region may be updated about static information related to map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof. Dynamic information related to a geographic region includes a detected presence and/or a reported presence of vehicles in parking lanes, dimensions of vehicles in parking lanes, vehicle speeds in the geographic region, real-time weather conditions, traffic conditions, presence of street lighting and shadows, nearby unmanned autonomous vehicle information, weather data, driver preference information, map database information, online service information and the like. Examples of the input devices may include, but is not limited to, a touch screen, a keyboard, a mouse, a joystick, a microphone, and an image-capture device. Examples of the output devices may include, but is not limited to, a display, an IVI console, an AR display, heads-up display, a speaker, a haptic output device, or other sensory output devices.

In an aspect of the disclosure, the processor 202 may compute a pedestrian real-time vulnerability index, based on historical information and static information related to a geographic region where the pedestrian is located. In an aspect, a weighted linear regression model may be used to calculate the pedestrian real-time vulnerability index. In another aspect, a look-up table may be employed for calculating the pedestrian real-time vulnerability index, where the look-up table is populated with entries of prior pedestrian real-time vulnerability indices based on input factors.

In another aspect, a machine learning model, such as trained machine u

In an aspect, the trained machine learning model 210 may be complemented or substituted with a transfer learning model, used by the system 102 may be trained by transfer learning. Transfer learning may be based on the fact that knowledge for one type of problem may be used to solve a similar problem. Fine-tuning a pretrained network with transfer learning is typically much faster and easier than training from scratch which requires the least amount of data and computational resources. Transfer learning uses knowledge from one type of problem to solve similar problems. One may start with a pretrained network and use it to learn a new task. One advantage of transfer learning is that the pretrained network has already learned a rich set of features. These features can be applied to a wide range of other similar tasks. For example, a trained machine learning model 210 trained on an enormous amount of static and/or dynamic information for a geographic region may be selected and retrained for new object classification using only hundreds of example datasets. The transfer learning model may be used when the static information and/or the dynamic information for the geographic region where the pedestrian is located is unavailable, sparse, incomplete, corrupted or otherwise unreliable for determining the pedestrian real-time vulnerability index. The transfer learning model may then use prior static information and/or prior dynamic information from other prior geographic regions to compute a pedestrian real-time vulnerability index for the new geographic region. For example, if contextual features and/or sensor data from prior intersections and left turn attempts indicate that a narrow road with high-profile vehicles in parking lanes may indicate a higher pedestrian real-time vulnerability index, that set of information may be probative for computing the pedestrian real-time vulnerability index in the current situation the driver faces.

In an aspect, the pedestrian real-time vulnerability index may be determined by weighting static, historical information and/or dynamic, real-time information for the geographic region where the pedestrian is located. The system 102 may weigh information such as LoS between the vehicle and the pedestrian more heavily, along with dynamic information about side and height of vehicles in a parking lane or other obstructions that imped a clear LoS. For example, in an aspect on a wider road with small size, low profile vehicles of low count at the location and time of the pedestrian approaching a crossing, the pedestrian real-time vulnerability index may be determined to be lower, lowering the risk to the pedestrian to cross a road at a certain geographic location without endangering the pedestrian or vehicle safety. In an aspect, higher speed limits and higher real-time observed vehicle speeds in the geographic region and/or higher previous accident data for the geographic region may be weighted higher in calculating the pedestrian real-time vulnerability index. The system 102 may then issue a pedestrian warning indicator or alert to the pedestrian or vehicle operator. The system 102 may provide step-by-step instructions to the pedestrian to walk to a safer location to cross the road. In an aspect, the system 102 may issue a pedestrian warning indicator to a vehicle, whether a conventional vehicle, AV or driver-assisted vehicle, to alert to the presence of pedestrians or a higher risk of accident with a pedestrian for the given geographic region.

In an aspect of the disclosure, when pedestrian real-time vulnerability index is computed, the system 102 could decide to avoid the most risky areas/intersections where the vulnerability index is high, especially in the presence of children. The vulnerability index could also be used as an input for car routing algorithms to avoid or add more weight on such links and intersections where the vulnerability index is high. In an aspect, drivers (human or AV) could be alerted when approaching areas with a high vulnerability index or asked to change lanes when relevant in order to avoid having a pedestrian crossing the street “out of nowhere,” such as a pedestrian appearing from behind a parked SUV or commercial van.

In an aspect, the system 102 may issue a pedestrian warning indicator through notification in AR or in audio commands to pay attention when crossing from behind a vehicle and, for example, to be more visible before attempting to cross, for the pedestrian to avoid surprising operators of vehicles.

Datasets comprising the sensor data may be used for building the trained machine learning model 210 with all left turn decisions and left turn risk factors to be determined. For building the machine learning model 210, the sensor data may be obtained for fixed time duration, and a reference left turn decision or left turn risk factor may be assigned in the training data (such as, the sensor data) to learn from. Further, the contextual features that represent motion dynamics or stationarity may be determined, stored and fed to the machine learning model 210 building technique. Further, for building the machine learning model 210, the sensor data may be fed to the model building technique to run it to build and obtain the machine learning model 210. The left turn decision and/or left turn risk factor may be a target output used to build the machine learning model 210, and the contextual features that represent motion dynamics or stationarity constitute as input to the machine learning model 210 corresponding to the target output. In accordance with an aspect, the machine learning model building technique may correspond to a classification technique, such as, but not limited to, decision trees and random forest.

In accordance with an aspect, various data sources may provide the static information and/or the dynamic information related to the geographic region where the pedestrian may cross a road as an input to the trained machine learning model 210. In accordance with an aspect, the static information and/or the dynamic information related to the geographic region may be provided as an input to the machine learning model 210. Examples of the machine learning model 210 may include, but not limited to, Decision Tree (DT), Random Forest, and Ada Boost. In accordance with an aspect, the memory 204 may include processing instructions for training of the machine learning model 210 with data set that may be dynamic, real-time (or near real time) data or static, historical data. In accordance with an aspect, the data may be obtained from one or more service providers.

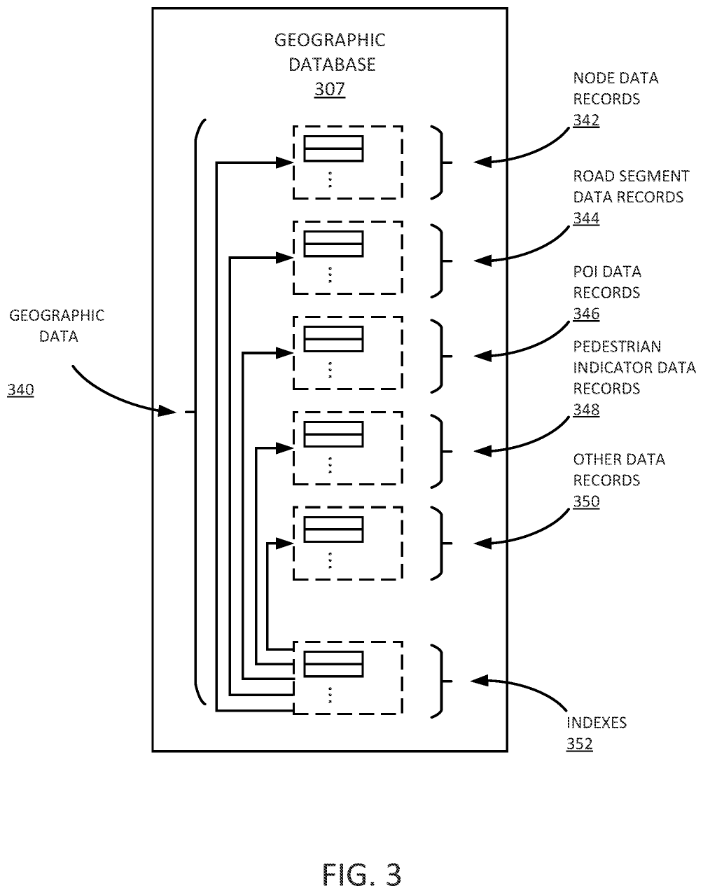

FIG. 3 illustrates an example map or geographic database 307, which may include various types of geographic data 340, the database may be similar to or an example of the database 108B. The data 340 may include but is not limited to node data 342, road segment or link data 344, map object and point of interest (POI) data 346, pedestrian indicator data records 348, or the like (e.g., other data records 350 such as traffic data, sidewalk data, road dimension data, building dimension data, vehicle dimension/turning radius data, etc.). Other data records may include computer code instructions and/or algorithms for executing a trained machine learning model that is capable of providing a pedestrian real-time vulnerability index based on static information and/or dynamic information related to the geographic region where a pedestrian is located.

A profile of end user driving data (e.g., a driving profile) such as end user driving and turning patterns and pedestrian traffic (e.g., hesitations/cautious, slow, fast, etc.) may be obtained by any functional manner including those detailed in U.S. Pat. Nos. 9,766,625 and 9,514,651, both of which are incorporated herein by reference. This data may be stored in one of more of the databases discussed above including as part of the pedestrian indicator data records 348 in some aspects. This data may also be stored elsewhere and supplied to the system 102 via any functional means.

In one aspect, the following terminology applies to the representation of geographic features in the geographic database 307. A “Node”—is a point that terminates a link, a “road/line segment”—is a straight line connecting two points, and a “Link” (or “edge”) is a contiguous, non-branching string of one or more road segments terminating in a node at each end. In one aspect, the geographic database 307 follows certain conventions. For example, links do not cross themselves and do not cross each other except at a node. Also, there are no duplicated shape points, nodes, or links. Two links that connect each other have a common node.

The geographic database 307 may also include cartographic data, routing data, and/or maneuvering data as well as indices 352. According to some example aspects, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the geographic database 307 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The geographic database 307 can include data about the POIs and their respective locations in the POI records. The geographic database 307 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the geographic database 307 can include event data (e.g., traffic incidents, construction activities, scheduled events, unscheduled events, etc.) associated with the POI data records or other records of the map database.

The geographic database 307 may be maintained by a content provider, e.g., the map data service provider or OEM map data provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The geographic database 307 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the geographic database 307 may be a master geographic database, but in alternate aspects, a client-side map database may represent a compiled navigation database that may be used in or with end user devices to provide navigation and/or map-related functions. For example, the map database may be used with the mobile device to provide an end user with navigation features. In such a case, the geographic database 307 can be downloaded or stored on the end user device which can access the geographic database 307 through a wireless or wired connection, such as via a processing server and/or a network, for example.

The records for pedestrian indicator data records 348 may include various points of data such as, but not limited to: road images, vehicle images, images of objects proximate to a vehicle, location and time/date information, height, weight, and data on other vehicles or objects present at the time when a pedestrian is in the geographic region with road crossings, etc. Vehicle driving profile data may also be included in the passenger indicator data records 348 (or stored elsewhere). Vehicle driving profile data such as the driving capabilities, reaction time, typical turn duration, etc. may be included in some driving profiles.

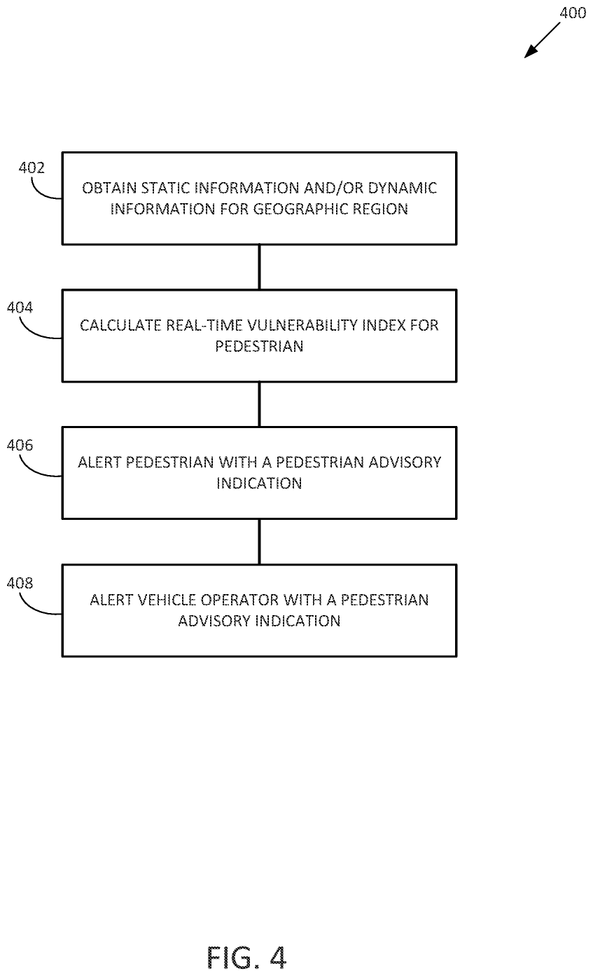

FIG. 4 illustrates a flowchart 400 for acts taken in an exemplary method for computing a pedestrian real-time vulnerability index based on static, historical information and/or dynamic, real-time information in the geographic region where a pedestrian is located, in accordance with an aspect. FIG. 4 is explained in conjunction with FIG. 1 to FIG. 3. The control starts at act 402.

At act 402, static information related to the geographic region near the pedestrian and/or dynamic information related to the geographic region near the pedestrian may be obtained for a time duration. In an aspect, the processor 202 may be configured to obtain the static information including, but not limited to, map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof.

In an aspect, the processor 202 may be configured to obtain the dynamic, real-time information related to the geographic region near the pedestrian, including, but not limited to a detected presence and/or a reported presence of vehicles in parking lanes, dimensions of vehicles in parking lanes, vehicle speeds in the geographic region, real-time weather conditions, traffic conditions, presence of street lighting and shadows or a combination thereof.

AVs may detect pedestrians from image segmentation and the various car sensors, however this implies having a direct LoS with the pedestrian. When a child or a person runs from behind a high vehicle, the AV may not have the time to avoid this person. Therefore, the system 102 may consider every hidden spot as a potential risk, especially when vehicles are high and would not allow the head of a person to be seen. For the system 102 having such a map with pedestrian real-time vulnerability indices would be useful for AVs which would know in which areas to pay even more attention.

Dynamic information related to micro-mobility vehicles (e.g., electric scooters, e-bikes, Segway-type electric vehicles and the like) may be obtained as more and more fast-moving light vehicles are coming to cities, with some benefits in term of mobility but also causing fatal accidents in others. The system 102 may obtain static information and/or dynamic information of which areas on the streets/roads or even on the sidewalks in the geographic region offer lower visibility and offer limited LoS may assist in computing the pedestrian real-time vulnerability index and enhance pedestrian safety.

In an aspect, when visibility is very limited, one possible indicator that a pedestrian is about to cross is when a pet is seen first on the edge of the road, then very likely followed by a human. Similarly, people may be walking with an accompanying drone controlled by the pedestrian or autonomous which acts as a “scout,” to indicate the presence of a pedestrian 2-3 meters after that. The small “scout” drone may be used as a source of dynamic information for computing the pedestrian real-time vulnerability index for a given area and context and the “scout” drone may decide or be controlled to act based on this data, e.g., by proactively being more visible in dangerous crossing.

In an aspect, the pedestrian real-time vulnerability index may be computed by weighting static, historical information and/or dynamic, real-time information related to the geographic region to assist a pedestrian, such as road dimensions, parked vehicle size and profile, shared or AVs observed at the time the pedestrian may be attempting to cross a road, or historical information about vehicle sizes and counts for the area of the intersection, real-time weather, LoS, lighting/shadows, etc. For example, on a wider road with small size parked vehicles of low count at the location and time of the attempted pedestrian crossing, the pedestrian real-time vulnerability index may be lower and the system 102 may alert the pedestrian to proceed with a road crossing, without endangering the pedestrian's or vehicle's safety. In an aspect, accident data for the geographic region may be weighted higher in computing the pedestrian real-time vulnerability index. In an aspect, higher accident data for the geographic region may indicate a more dangerous road crossing area and indicate this to the pedestrian or approaching vehicle with a pedestrian indicator warning.

In an aspect, the dynamic information may be obtained from one or more user equipment (UE). In an aspect of the disclosure, the UE may correspond to a mobile phone or an electronic device associated with the user or vehicle, such as an on-board vehicle computer, an IVI, smart phones, smart watches, smart wearable devices, tablets, laptop or notebook computers or other mobile devices. In an aspect, the UE may include sensors associated with devices external to the vehicle and the user, such as weather sensors, positioning beacons and sensors, satellite, cellular and wide-area-network-connected sensors, RFID sensors or other external remote sensor devices and UEs known to one of skill in the art for vehicle transportation and traffic information systems.

At act 404, a real-time vulnerability index for the pedestrian based on the static information related to the geographic region near the pedestrian and/or the dynamic information related to the geographic region near the pedestrian is computed. The pedestrian real-time vulnerability index may be computed by analyzing the static information related to the geographic region near the pedestrian and/or the dynamic information related to the geographic region to calculate the pedestrian real-time vulnerability index to allow the pedestrian to cross a road safely in the geographic region.

In an aspect, a weighted linear regression model may be used to compute the pedestrian real-time vulnerability index. In another aspect, a machine learning model, such as trained machine learning model 210 discussed earlier, may be used to compute pedestrian real-time vulnerability index. In an aspect, the machine learning model may be complemented or substituted with a transfer learning model. The transfer learning model may be used when the static information related to the geographic region near the pedestrian and/or the dynamic information related to the geographic region is unavailable, sparse, incomplete, corrupted or otherwise unreliable for determining the pedestrian real-time vulnerability index. The transfer learning model may then use prior static information related to a prior geographic region near the pedestrian and/or prior dynamic information related to a prior geographic region near the pedestrian in computing the pedestrian real-time vulnerability index. For example, if prior static information related to a prior geographic region near the pedestrian and/or prior dynamic information related to a prior geographic region near the pedestrian indicate that a smaller road with larger vehicles would indicate a higher pedestrian real-time vulnerability index, that set of information may be probative for determining the pedestrian real-time vulnerability index in the current situation the driver faces.

At act 406, the pedestrian is alerted to the pedestrian real-time vulnerability index with a pedestrian advisory indication. Depending on the level of the pedestrian real-time vulnerability index, the system 102 may issue the pedestrian advisory indication with an audible pedestrian advisory indication, a visual pedestrian advisory indication, a haptic pedestrian advisory indication or a combination thereof. The pedestrian advisory indication may be of higher volume, brighter visual alerts (such as a bright red indicator for higher risk pedestrian crossings and green indicator for lower risk pedestrian crossings), verbal messages with directions, text messages, TTY messages, SMS or other types of message presentation to the pedestrian via his/her UE. In an aspect of the disclosure, the pedestrian may be alerted to the calculated pedestrian real-time vulnerability index by alerts or prompts or instructions to direct the pedestrian to the road crossing safely. In an aspect, the alerts or prompts may include instructing the pedestrian with an audible alert, a visual alert, a vehicle console display alert, an augmented reality-based alert, a heads-up display alert, a haptic alert (such as a vibration on the steering wheel), IVI displays and sounds, etc. In addition, other sensors can be leveraged, such as LiDAR, radar or proximity sensors to alert the pedestrian to the road crossing based on the level of the pedestrian real-time vulnerability index. In an aspect, audio cues can be used as well as if the pedestrian is soon approaching the road crossing, beeping increasingly when approaching a more risky road crossing. In an aspect, the frequency, duration, volume, brightness or other indicia of the pedestrian advisory indication directed to the pedestrian may increase as the vehicle approaches closer to the road crossing.

At night or other low-light conditions such as shadowed areas or weather-obscured visibility (e.g., heavy rain or snow), the calculated pedestrian real-time vulnerability index may be more relevant as visibility is more limited and thus street lighting may be considered for optimal recommendation. Some mechanisms are known in the art for low-light visibility, including using reflective surfaces and flashlights. In an aspect, the system 102 may issue a pedestrian advisory indication to prefer some areas which are better lit or to recommend when to pay attention to activate the flashlight when relevant.

In an aspect, other pedestrian advisory indications may be used, such as a pedestrian making itself more visible, especially when crossing the road. This could be done by alerting the pedestrian to wave a hand when the body of the person is hidden behind a high vehicle before crossing. In an aspect, a hologram may be used as a pedestrian advisory indication. The hologram may show/project a form ahead of the pedestrian before actually stepping on the road to that drivers have time to get used to the pedestrian presence, or catch the driver's attention. In another aspect, a pedestrian may have a “physical retractable object/arm” which could project 50-70 cm ahead of the pedestrian to indicate they are about to cross, in response to the pedestrian advisory indication. This would be similar to a “flashlight for the daytime.”

At act 408, a vehicle operator (such as a human driver, AV or human-assisted AV) is alerted to the pedestrian real-time vulnerability index with a pedestrian advisory indication directed to the vehicle UE for presentation and notification of the pedestrian advisory indication. The system 102 may, in addition to the pedestrian advisory indication directed to the pedestrian, issue an alert to the vehicle operator as the vehicle approaches the pedestrian or pedestrian road crossing. In an aspect, as discussed above, depending on the level of the pedestrian real-time vulnerability index, the system 102 may issue the pedestrian advisory indication to the vehicle operator with an audible pedestrian advisory indication, a visual pedestrian advisory indication, a haptic pedestrian advisory indication or a combination thereof. The pedestrian advisory indication may be of higher volume, brighter visual alerts (such as a bright red indicator for higher risk pedestrian crossings and green indicator for lower risk pedestrian crossings), verbal messages with vehicle directions, text messages, TTY messages, SMS or other types of message presentation to the vehicle operator via the vehicle or user UE.

Blocks of the flowchart 400 support combinations of means for performing the specified functions and combinations of operations for performing the specified functions. It will also be understood that one or more blocks of the flowchart 400, and combinations of blocks in the flowchart 400, can be implemented by special purpose hardware-based computer systems which perform the specified functions, or combinations of special purpose hardware and computer instructions.

Alternatively, the system 102 may comprise means for performing each of the operations described above. In this regard, according to an example aspect, examples of means for performing operations may comprise, for example, the processor 202 and/or a device or circuit for executing instructions or executing an algorithm for processing information as described above.

Although the aforesaid description of FIGS. 1-4 is provided with reference to the sensor data, however, it may be understood that the disclosure would work in a similar manner for different types and sets of data as well. The system 102 may generate/train the trained machine learning model 210 to evaluate different sets of data at various geographic locations. Additionally, or optionally, the calculated pedestrian real-time vulnerability index may be provided to an end user, as an update which may be downloaded from the mapping platform 110. The update may be provided as a run time update or a pushed update.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present disclosure and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system to compute a real-time vulnerability index for a pedestrian walking along a road in a geographic region near the pedestrian, the system comprising:
at least one memory configured to store computer executable instructions; and
at least one processor configured to execute the computer executable instructions to:
obtain static information related to the geographic region near the pedestrian and/or dynamic information related to the geographic region near the pedestrian;
compute the real-time vulnerability index for the pedestrian based on the static information related to the geographic region near the pedestrian and/or the dynamic information related to the geographic region near the pedestrian; and
alert the pedestrian to the real-time vulnerability index with a pedestrian advisory indication.

2. The system of claim 1, where the computer executable instructions to obtain the static information related to the geographic region near the pedestrian comprise computer executable instructions to obtain map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof.

3. The system of claim 1, where the computer executable instructions to obtain dynamic information related to the geographic region near the pedestrian comprise computer executable instructions to obtain a detected presence and/or a reported presence of vehicles in parking lanes, dimensions of vehicles in parking lanes, vehicle speeds in the geographic region, real-time weather conditions, traffic conditions, presence of street lighting and shadows or a combination thereof.

4. The system of claim 1, where the computer executable instructions to alert the pedestrian to the real-time vulnerability index with the pedestrian advisory indication comprise computer readable instructions to alert the pedestrian with an audible pedestrian advisory indication, a visual pedestrian advisory indication, a haptic pedestrian advisory indication or a combination thereof.

5. The system of claim 1, further comprising computer executable instructions to alert an operator of a vehicle in motion and approaching a location of the pedestrian to a presence of the pedestrian outside of a line-of-sight between the vehicle and the pedestrian.

6. The system of claim 1, where the computer executable instructions to compute the real-time vulnerability index comprises computer executable instructions to use a trained machine learning model to compute the real-time vulnerability index.

7. The system of claim 6, where the computer executable instructions to use the trained machine learning model comprise computer executable instructions to use a weighted linear regression model.

8. The system of claim 6, where the computer executable instructions to use the trained machine learning model comprise computer executable instructions to use a transfer learning model based on a plurality of prior static information related to a different geographic region and/or a plurality of prior dynamic information related to the different geographic region.

9. A method for computing a real-time vulnerability index for a pedestrian walking along a road in a geographic region near the pedestrian, the method comprising:
obtaining static information related to the geographic region near the pedestrian and/or dynamic information related to the geographic region near the pedestrian;
computing the real-time vulnerability index for the pedestrian based on the static information related to the geographic region near the pedestrian and/or the dynamic information related to the geographic region near the pedestrian; and
alerting the pedestrian to the real-time vulnerability index with a pedestrian advisory indication.

10. The method of claim 9, where obtaining the static information related to the geographic region near the pedestrian comprises obtaining map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof.

11. The method of claim 9, where obtaining dynamic information related to the geographic region near the pedestrian comprises obtaining a detected presence and/or a reported presence of vehicles in parking lanes, dimensions of vehicles in parking lanes, vehicle speeds in the geographic region, real-time weather conditions, traffic conditions, presence of street lighting and shadows or a combination thereof.

12. The method of claim 9, where alerting the pedestrian to the real-time vulnerability index with the pedestrian advisory indication comprises alerting the pedestrian with an audible pedestrian advisory indication, a visual pedestrian advisory indication, a haptic pedestrian advisory indication or a combination thereof.

13. The method of claim 9, where computing the real-time vulnerability index comprises using a trained machine learning model to compute the real-time vulnerability index.

14. The method of claim 13, where using the trained machine learning model comprises using a transfer learning model based on a plurality of prior static information related to a different geographic region and/or a plurality of prior dynamic information related to the different geographic region.

15. A computer program product comprising a non-transitory computer readable medium having stored thereon computer executable instructions, which when executed by one or more processors, cause the one or more processors to carry out operations to compute a real-time vulnerability index for a pedestrian walking along a road in a geographic region near the pedestrian, the operations comprising:
obtaining static information related to the geographic region near the pedestrian and/or dynamic information related to the geographic region near the pedestrian;
computing the real-time vulnerability index for the pedestrian based on the static information related to the geographic region near the pedestrian and/or the dynamic information related to the geographic region near the pedestrian; and
alerting the pedestrian to the real-time vulnerability index with a pedestrian advisory indication.

16. The computer program product of claim 15, where the operations for obtaining the static information related to the geographic region near the pedestrian comprise operations for obtaining map model data and/or geodata information to compute one or more lines-of-sight in the geographic region, parking lane information, bike lane information, historical weather conditions, historical pedestrian accident information, historical autonomous vehicle activity in the geographic region, a time of day to compute daylight available in the geographic region, vehicle speed limits in the geographic region or a combination thereof.

17. The computer program product of claim 15, where the operations for obtaining dynamic information related to the geographic region near the pedestrian comprise operations for obtaining a detected presence and/or a reported presence of vehicles in parking lanes, dimensions of vehicles in parking lanes, vehicle speeds in the geographic region, real-time weather conditions, traffic conditions, presence of street lighting and shadows or a combination thereof.

18. The computer program product of claim 15, where the operations for alerting the pedestrian to the real-time vulnerability index with the pedestrian advisory indication comprise operations for alerting the pedestrian with an audible pedestrian advisory indication, a visual pedestrian advisory indication, a haptic pedestrian advisory indication or a combination thereof.

19. The computer program product of claim 15, where the operations for computing the real-time vulnerability index comprise operations for using a trained machine learning model to compute the real-time vulnerability index.

20. The computer program product of claim 19, where the operations for using the trained machine learning model comprise operations for using a transfer learning model based on a plurality of prior static information related to a different geographic region and/or a plurality of prior dynamic information related to the different geographic region.
